(19) United States
(12) Patent Application Publication
(10) Pub. No.: US 2025/0045423 A1
(43) Pub. Date: Feb. 6, 2025

(54) MICROPROCESSOR EQUIPPED WITH A HARDWARE SECURITY MODULE

(71) Applicant: Commissariat à l'Energie Atomique et aux Energies Alternatives, Paris (FR)

(72) Inventor: Olivier SAVRY, Grenoble Cedex 09 (FR)

(73) Assignee: Commissariat à l'Energie Atomique et aux Energies Alternatives, Paris (FR)

(21) Appl. No.: 18/790,786

(22) Filed: Jul. 31, 2024

(30) Foreign Application Priority Data
Jul. 31, 2023 (FR) 2308277

(51) Int. Cl. G06F 21/60; G06F 21/54

(52) U.S. Cl. CPC G06F 21/602; G06F 21/54

(57) ABSTRACT

The security hardware module is configured to:
when a datum Dᵢ is written to a register R_{i,0} of the microprocessor:
   compute a code C_{i,α2} using a function Q_{α2} parameterized by a secret key α2, then
   record the code C_{i,α2} in a register of an auxiliary bank and mark this register as having been updated,
only when all the registers of the auxiliary bank have been marked, triggering, at a time tr₁, replacement of a current secret key α1 by the key α2 and, for any new arithmetic logic instruction, the execution of which starts after this time tr₁, using the secret key α2 and the codes C_{i,α2} recorded in the auxiliary bank of registers instead of the key α1 and codes C_{i,α1}, respectively, to compute and verify a code Cᵣₑₛₜ₋ₜ.

The invention relates to a microprocessor equipped with a hardware security module and to a method for executing a machine code using this microprocessor.

To obtain information on a binary code or to cause unexpected operation of the binary code, many attacks are possible. For example, attacks known as fault injection or fault attacks may be employed. These attacks consist in disrupting operation of the microprocessor or of the memory containing the binary code, via various physical means such as modification of supply voltages, modification of the clock signal, exposure of the microprocessor to electromagnetic waves, inter alia.

Using such attacks, an attacker is able to degrade the integrity of machine instructions or data with a view for example to retrieving a secret key of a cryptographic system, bypassing security mechanisms such as verification of a PIN code during authentication or simply preventing execution of a function that is essential to the security of a critical system.

These attacks may in particular cause three types of errors, called execution errors, during execution of the binary code:
1) alteration of instructions of the executed machine code,
2) alteration of data stored in the main memory or in registers of the microprocessor, and
3) alteration of the control flow of the machine code.

The control flow corresponds to the execution path followed during execution of the machine code. Control flow is conventionally represented in the form of a control flow graph.

To detect such execution errors, it has already been proposed to associate an integrity code with each datum processed by the microprocessor. The integrity code associated with the result of the instruction that processes this data is then computed from the integrity codes of the processed data. Thus, if an error occurs during execution of this instruction, the result obtained does not correspond to the computed integrity code. This allows this error to be detected.

The integrity code is constructed from the datum and, in addition, using a secret key known only to the microprocessor. Thus, it is difficult for an attacker to modify an integrity code so that it corresponds to an erroneous result since she or he does not know the secret key. It is necessary however for it to always be possible to construct the integrity code of the result using the integrity codes associated with the processed data and without using the result of the instruction executed by the arithmetic logic unit. For example, such a solution is described in patent application EP 4089559. In this patent application, i.e. in EP 4089559, the described hardware circuits for computing the integrity code corresponding to a particular arithmetic logic operation are simple and fast because the function Q_{α} used to compute the integrity code uses conditional permutations to that end. More precisely, the function Q_{α} uses permutations parameterized by a secret key α. Thus, by virtue of use of this function Q_{α}, computation of integrity codes is fast and hence slows down execution of the machine code by the microprocessor little or not at all.

However, the secret key a used by the function Q_{α} may be determined fairly easily provided that a plurality of pairs (Dᵢ, Q_{α}(Dᵢ)) are known, where Dᵢ is a datum and Q_{α}(Dᵢ) is the integrity code computed for the datum Dᵢ using the function Q_{α}. This is therefore a weakness in the microprocessor implementing this function Q_{α} that may be exploited to compromise the security of the microprocessor.

Prior art is also known from EP 2490148B1 and from the following article: Wali I et al.: “A Hybrid Fault-Tolerant Architecture for Highly Reliable Processing Cores”, Journal of Electronic Testing, Kluwer Academic Publishers, Dordrecht, NL, vol. 32, No. 2, March 2016, pages 147-161.

The objective is to provide a microprocessor the security of which is able to be improved while using, to compute the integrity code, hardware circuits that are as simple and fast as those disclosed in patent application EP 4089559.

The invention is defined in the attached set of claims.

The invention will be better understood on reading the following description, which is given merely by way of non-limiting example and with reference to the drawings, in which:

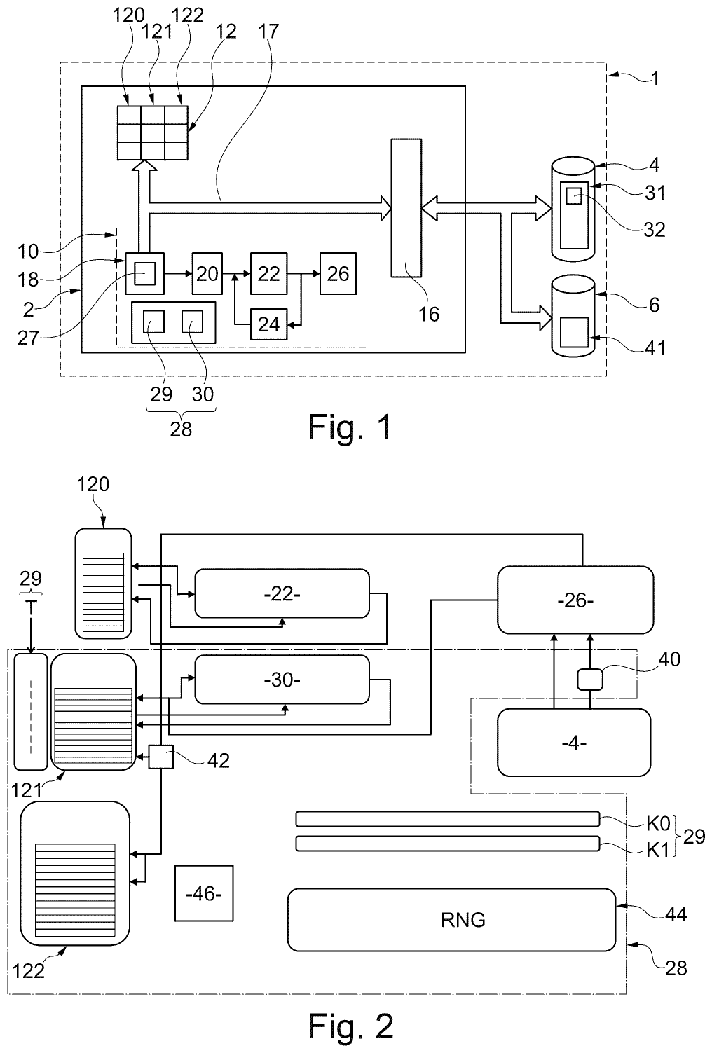

FIG. 1 is a schematic illustration of the architecture of an electronic computer capable of executing a binary code;

FIG. 2 is a schematic illustration of the structure of a hardware security module used in the computer of FIG. 1,

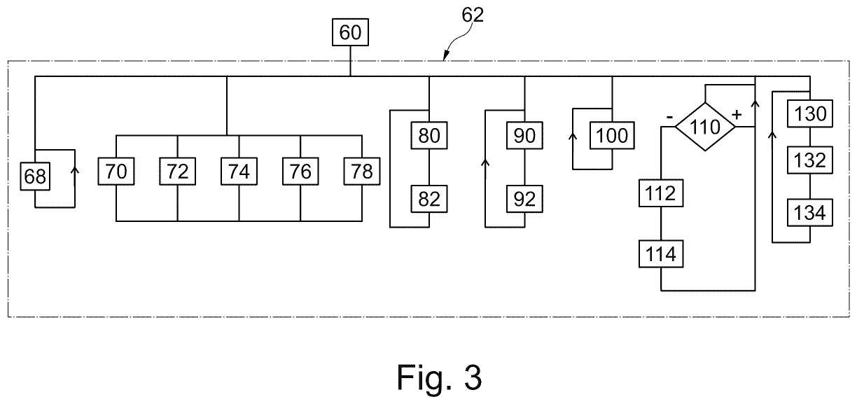

FIG. 3 is a flowchart of a method for executing the binary code by means of the computer of FIG. 1.

In this description, the terminology, the conventions and the definitions of the terms used in this text are introduced in section I. Next, detailed examples of embodiments are described in section II with reference to the figures. In section III, variants of these embodiments are presented. Lastly, the advantages of the various embodiments are described in section IV.

### Section I: Definitions, Terminologies and Conventions

In the figures, the same references have been used to designate elements that are the same.

In the remainder of this description, features and functions well known to those skilled in the art are not described in detail.

A “program” designates a set of one or more predetermined functions that it is desired to have executed by a microprocessor.

An “instruction” designates a machine instruction executable by a microprocessor. Such an instruction consists of:
an opcode, or operation code, encoding the nature of the operation to be executed, and
one or more operands defining the one or more values of the parameters of this operation.

The registers in which the one or more data to be processed by an instruction are recorded are typically identified by one or more operands of the instruction. Likewise, the register in which the result of execution of an instruction must be recorded may also be identified by an operand of this instruction.

By “logic instruction”, what is meant is an instruction of the instruction set of the microprocessor that, when it is executed by the arithmetic logic unit, records in a register Rᵣₑₛ₋ₚ of the microprocessor the result of a Boolean operation. The opcode of the logic instruction identifies the Boolean operation to be executed by the arithmetic logic unit to modify or combine the one or more data D₁ to Dₙ. Below, the symbol “&” is used to generically designate a Boolean operation. Thus, the notation D₁&D₂& . . . &Dₙ generically designates a Boolean operation executed by the microprocessor 2 between the data D₁ to Dₙ. In the case where n=1, the Boolean operation is the complement operation also known as the Boolean operation “NOT”. In the case where n is greater than or equal to two, the Boolean operation is chosen from the group consisting of the following Boolean operations and their composition:
the logic operation “OR”,
the logic operation “EXCLUSIVE OR”,
the logic operation “AND”.

By “arithmetic instruction”, what is meant is an instruction of the instruction set of the microprocessor that, when it is executed by the arithmetic logic unit, records in a register Rᵣₑₛ₋ₚ of the microprocessor the result of an arithmetic operation. An arithmetic operation is different from a Boolean operation. Typically, an arithmetic operation belongs to the group made up of bit-shift operations, bit-rotation operations, addition operations, multiplication operations, and division operations.

By “arithmetic logic instruction”, what is meant is both a logic instruction and an arithmetic instruction and the symbol “*” is used to generically designate the corresponding Boolean or arithmetic operation. Below, unless otherwise indicated, the term “instruction” designates an arithmetic logic instruction.

A “machine code” is a set of machine instructions. It is typically a file containing a succession of bits having the value “0” or “1”, these bits encoding the instructions to be executed by the microprocessor. The machine code is executable by the microprocessor directly, i.e. without prior compilation or interpretation being required.

A “binary code” is a file containing a succession of bits having the value “0” or “1”. These bits encode data and instructions to be executed by the microprocessor. Thus, the binary code comprises at least one machine code and in addition, generally, digital data processed by this machine code.

Execution of a function is spoken of to designate execution of the instructions performing this function.

The size of a datum is equal to the number of bits contained in the datum.

### SECTION II: EXAMPLE OF EMBODIMENT

FIG. 1 shows an electronic computer 1 comprising a microprocessor 2, a main memory 4 and a mass storage medium 6. For example, the computer 1 is a desktop computer, a smartphone, an electronic tablet, a chip card or the like.

The microprocessor 2 here comprises:
a hardware pipeline 10 for processing the instructions to be executed,
a set 12 of registers,
a data input/output interface 16, and
a bus 17 that connects the various components of the microprocessor 2 to one another.

The memory 4 is configured to store instructions of a binary code 31 of a program that must be executed by the microprocessor 2. The memory 4 is a random-access memory. Typically, the memory 4 is a volatile memory. The memory 4 may be a memory external to the microprocessor 2, as shown in FIG. 1. In this case, the memory 4 is, for example, produced on a substrate that is mechanically separate from the substrate on which the various elements of the microprocessor 2, such as the pipeline 10, are produced.

By way of illustration, the binary code 31 in particular comprises a machine code 32 of a secure function. Each secure function corresponds to a set of a plurality of lines of code, for example several hundreds or thousands of lines of code, recorded at successive addresses in the memory 4. Here, each line of code corresponds to one machine word. Thus, a line of code is loaded into a register of the microprocessor 2 in a single read operation. Likewise, a line of code is written to the memory 4 by the microprocessor 2 in a single write operation. Each line of code encodes either a single instruction or a single datum.

The medium 6 is typically a non-volatile memory. For example, it is an EEPROM or flash memory. Here it contains a backup copy 41 of the binary code 31. Typically, it is this copy 41 that is automatically copied to the memory 4 to restore the code 31, for example after a power cut or the like or just before execution of the code 31 starts.

By way of illustration, the microprocessor 2 has an ARMv7 architecture (ARMv7 standing for Advanced RISC Machine version 7) and supports instruction sets such as Thumb1 and/or Thumb2. An instruction set defines in a limiting manner the syntax of the instructions that the microprocessor 2 is capable of executing. This instruction set therefore in particular defines the set of possible opcodes of an instruction.

In this example of embodiment, the set 12 comprises general registers that are usable to store any type of data, and dedicated registers. Unlike the general registers, the dedicated registers are dedicated to storage of particular data generally automatically generated by the microprocessor 2.

In this embodiment, the set 12 comprises a main bank 120 of registers and two auxiliary banks 121 and 122 of registers. The auxiliary banks 121 and 122 are identical to the main bank 120.

The bank 120 is used to store the data processed and used by the processing pipeline 10. To this end, the bank 120 is configured to allow a plurality of data to be read and a plurality of data to be written simultaneously. For this purpose, typically, the bank 120 comprises a plurality of address ports and a plurality of read/write ports.

Typically, the bank 120 comprises 64 or 32 registers or less and generally more than eight registers. The size of each register of the bank 120 is equal to the size of the data processed by the arithmetic logic unit of the microprocessor 2. The size, in number of bits, of each datum processed is equal to 2^{d}, where d is an integer greater than two. For example, here, the size of each datum is equal to 32 bits or 64 bits.

The interface 16 is in particular able to acquire data and instructions, for example, from the memory 4 and/or medium 6 external to the microprocessor 2.

The pipeline 10 makes it possible to start executing an instruction of the machine code while processing, by the pipeline 10, of the previous instruction of this machine code has not yet finished. Such processing pipelines are well known and only elements of the pipeline 10 necessary to comprehension of the invention are described in greater detail.

The pipeline 10 typically comprises the following stages:
an instruction loader 18,
an instruction decoder 20,
an arithmetic logic unit 22 that executes the instructions,
a rewrite circuit 24,
a memory-access module 26, and
a hardware security module 28.

The loader 18 loads the next instruction to be executed by the unit 22 from the memory 4. More precisely, the loader 18 loads the instruction of the machine code 32 to which a program counter 27 points. Unless its value is modified by execution of a branching instruction, the value of the program counter 27 is incremented by a regular increment on each execution of an instruction by the arithmetic logic unit 22. The regular increment is equal to the difference between the addresses of two immediately consecutive instructions in the machine code 32.

The decoder 20 decodes the instruction loaded by the loader 18, to obtain configuration signals that configure the microprocessor 2, and in particular the unit 22, so that it executes, typically in the next clock cycle, the loaded instruction. One of these configuration signals encodes the nature of the operation to be executed by the unit 22. This configuration signal comes or is constructed from the opcode of the loaded instruction. Other configuration signals indicate, for example, whether the instruction is an instruction to load a datum from the memory 4 or to write a datum to the memory 4. These configuration signals are transmitted to the unit 22. Other configuration signals contain the values of the loaded operands. Depending on the instruction to be executed, these signals are transmitted to the set 12 of registers or to the unit 22.

The unit 22 executes the decoded instructions one after another.

The rewrite circuit 24 is capable of recording the result of execution of an instruction by the unit 22 in one or more of the registers of the set 12 of registers.

The memory-access module 26 is capable, via the interface 16, of loading data to be processed by the unit 22 into the set 12 of registers and of saving data recorded in the set 12 to the memory 4.

The module 28 is capable of automatically executing the various operations required to make execution of arithmetic logic instructions by the unit 22 secure. The module 28 functions independently and without using the unit 22. Thus, it is capable of working in parallel with the unit 22. To this end, it in particular comprises a secure non-volatile memory 29 and a computing unit 30. No access is provided to this memory 29 except through the module 28. In this embodiment, the module 28 is configured to execute operations such as the following operations:
verification of an integrity code,
construction of an integrity code Cᵢ from a datum Dᵢ,
construction of the integrity code Cᵣₑₛ₋ₜ of a result Dᵣₑₛ₋ₚ from integrity codes C_{1,α} to C_{n,α} of the processed data.

To carry out the latter operation, the unit 30 comprises a plurality of computation hardware circuits. Each of these computation hardware circuits constructs an integrity code Cᵣₑₛ₋ₜ of the result Dᵣₑₛ₋ₚ from the integrity codes C_{1,α} to C_{n,α} of the data D₁ to Dₙ processed by the unit 22 and without directly using the result Dᵣₑₛ₋ₚ produced by the unit 22. Here, there is one computation hardware circuit for the logic instructions and one computation hardware circuit for each arithmetic instruction, the execution of which must be secured. Here, these computation hardware circuits are the same as those described in patent application EP 4089559. They are therefore not described again here.

The unit 30 works in parallel with the unit 22. It may be considered to be another arithmetic logic unit, specialized however in the computation of the codes Cᵣₑₛ₋ₜ.

The memory 29 is used to store the secret information that the module 28 requires to operate. Here, it therefore in particular comprises the secret keys αₖ used by the module 28 to secure execution of the instructions by the unit 22.

FIG. 2 shows in greater detail one embodiment of the security module 28. In FIG. 2, the banks 121 and 122 are considered to form part of the module 28.

The module 28 comprises, in addition to the unit 30, in particular, conditional-permutation hardware circuits 40 and 42, a key generator 44 and a counter 46.

The conditional-permutation hardware circuit 40 is capable of computing the integrity code C_{i,α} of a datum Dᵢ loaded into the bank 120 by the memory-access module 26. For this purpose, the circuit 40 implements the following relationship: Cᵢ=Q_{α}(Dᵢ), where:
the index i identifies the datum Dᵢ, and
the function Q_{α} is a function preprogrammed into the module 28 and parameterized by the secret key α.

The function Q_{α} is the function described in detail in patent application EP 4089559. Here, it will simply be recalled that the function Q_{α} is defined by the following relationship: Q_{α}(Dᵢ)=P o F_{α}(Dᵢ), where P is a predetermined function and F_{α} is a function defined by the following relationship: F_{α}(Dᵢ)=E₀ o . . . o E_{q} o . . . o E_{NbE-1}(Dᵢ), where each function E_{q} is a transposition stage and the index q is an order number between zero and NbE-1, where NbE is an integer greater than one and less than or equal to d. Each transposition stage E_{q} is defined by the following relationship: E_{q}(x)=T_{αm,q} o . . . o T_{αj,q} o . . . o T_{α1,q} o T_{α0,q}(x), where:
x is a variable the size of which, in number of bits, is equal to the size of the datum Dᵢ,
T_{αj,q} is a conditional transposition, parameterized by the parameter α_{j,q},
“m+1” is the total number of transpositions T_{αj,q} of the stage E_{q},
“j” is an order number identifying the transposition T_{αj,q} among the other transpositions of the stage E_{q}, and
the symbol “o” designates the operation of function composition.

For example, here, the function P is the identity function.

Each conditional transposition T_{αj,q} permutes two blocks of bits B_{2j+1,q} and B_{2j,q} of the variable x when the parameter α_{j,q} is equal to a first value, one for example, and does not permute these two blocks of bits when the parameter α_{j,q} is equal to a second value, zero for example. The transposition T_{αj,q} differs from all the other transpositions of the function F_{α} in that it is the only one that permutes the two blocks B_{2j+1,q} and B_{2j,q} when the parameter α_{j,q} is equal to the first value. The blocks B_{2j+1,q} and B_{2j,q} of all the transpositions T_{αj,q} of the stage E_{q} are different from one another and do not overlap so that all the transpositions T_{αj,q} of the stage E_{q} can be executed in parallel.

For all the stages E_{q} for which q is less than NbE-1 and for all the transpositions T_{αj,q} of this stage, the blocks B_{2j+1,q} and B_{2j,q} are located inside a given block of larger size permuted by a transposition of the above stage E_{q+1} when the parameter of this transposition of the above stage E_{q+1} is equal to the first value.

The concatenation of the bits of all the parameters α_{j,q} of all the stages E_{q} is equal to the value of the secret key α.

The conditional-permutation hardware circuit 42 is capable of computing the integrity code Cᵢ of a datum Dᵢ written to the bank 120 by the rewrite circuit 24. For this purpose, the circuit 42 is structurally identical to the circuit 40.

The generator 44 generates keys a that are intended to be used by the unit 30 and the conditional-permutation circuits 40, 42. For example, the generator 44 is a random or pseudo-random number generator.

The counter 46 allows a predetermined number N_{c} of clock cycles of the microprocessor 2 to be counted. In a clock cycle, the unit 22 executes at most one instruction. The number No is chosen to be greater than or equal to a number Nₘᵢₙ. The number Nₘᵢₙ is equal to the minimum number of clock cycles required to be sure that execution of all the instructions in the process of being executed by the microprocessor 2 at the time when the counter 46 starts counting the clock cycles, has finished at the end of the Nₘᵢₙ counted clock cycles. Conversely, here, the number No is also chosen to be close to Nₘᵢₙ. For example, the number N_{c} is less than 10Nₘᵢₙ or less than 5Nₘᵢₙ and, preferably, less than 2Nₘᵢₙ. For this purpose, in most cases, the number No is between 5 and 500 or between 5 and 300.

The memory 29 in particular comprises:
a register K0 intended to contain a first secret key,
a register K1 intended to contain a second secret key different from the first secret key, and
a register T intended to mark the registers of the banks 121 and 122 that have been updated.

The size of the register T is equal to the number of registers contained in each of the banks 121 and 122.

Below, the register of the bank 120 that contains datum Dᵢ is denoted R_{i,0}. The registers of the banks 121 and 122 that each contain an integrity code associated with the datum Dᵢ are denoted R_{i,1} and R_{i,2}, respectively. The bit of the register T that indicates whether the registers R_{i,1} and R_{i,2} have been updated is denoted Tᵢ.

The way in which the microprocessor 2 operates to make execution of the arithmetic logic instructions secure will now be described in greater detail with reference to FIG. 3.

The method starts with an initializing phase 60. In phase 60, the binary code 31 is loaded into the memory 4 from the medium 6. All the registers of the banks 120, 121 and 122 are initialized to zero. All the bits Tᵢ of the register T are also initialized to zero. Lastly, the generator 44 generates two secret keys α1 and α2 and records them in the registers K0 and K1, respectively. The register K0 is marked as being the one containing the current secret key and the bank 121 is marked as being the current auxiliary bank. Below, the register K0 or K1 that is marked as being the one containing the current secret key is called the “current register K0 or K1”. The register K0 or K1 that is not marked as being the one containing the current secret key is called the “non-current register K0 or K1”. Similarly, the auxiliary bank that is not marked as being the current auxiliary bank is called the “non-current auxiliary bank”.

Next, a phase 62 of executing the binary code 31 by means of the microprocessor 2 starts.

At the start of phase 62, in a step 68, the counter 46 is triggered. The counter 46 increments automatically by one at the start of each clock cycle.

In phase 62, the instructions of the machine code are loaded one after another by the loader 18, then executed.

More precisely, for each of these instructions, in a step 70, the loader 18 loads the instruction to be executed.

Next, in a step 72, the loaded instruction is decoded by the decoder 20.

Next, in a step 74, the decoded instruction is executed by the unit 22. If the executed instruction is an arithmetic logic instruction, this causes an arithmetic or logic operation to be performed that is written in the general form D₁*D₂* . . . *Dₙ and the result of this operation is denoted Dᵣₑₛ₋ₚ. In the operation D₁*D₂* . . . *Dₙ:
the index n is equal to the number of data Dᵢ processed by the arithmetic logic instruction, the index n being greater than or equal to one,
D₁ to Dₙ are data recorded in registers R_{1,0} to R_{n,0} of the main bank 120, respectively,
the registers R_{1,0} to R_{n,0} are the registers designated by the operands of the arithmetic logic instruction,
the symbol “*” is the arithmetic or logic operation designated by the opcode of the arithmetic logic instruction.

Here, the bank 120 contains only the data Dᵢ to be processed and none of the integrity codes C_{i,ak} of these data.

In a step 76, the rewrite circuit 24 writes the result Dᵣₑₛ₋ₚ delivered by the unit 22 following execution of an arithmetic logic instruction to a register R_{res-p,0} of the bank 120.

In a step 78, the module 26 loads, into the bank 120, the data Dᵢ to be processed by the unit 22 before the unit 22 starts processing these data Dᵢ. Loading of a datum Dᵢ into the bank 120 is typically triggered by execution of a loading instruction by the unit 22. Conversely, in step 78, the module 26 may also trigger transfer of a datum Dᵢ recorded in the bank 120 to the memory 4. Such a transfer is generally also triggered by execution of a write instruction by the unit 22. Generally, to optimize transfer of data between the memory 4 and the microprocessor 2, cache memories are used. Since use of cache memories is conventional, this is not described here in detail.

Each of steps 70 to 78 may be executed in parallel with the others, this in particular allowing execution of an instruction to be started before the end of execution of the preceding instruction or instructions.

In parallel with steps 70 to 78, the module 28 makes operation of the microprocessor 2 secure, in particular against fault-injection attacks. For this purpose, as explained below, the module 28 frequently changes the current secret key. Thus, the module 28 successively uses the keys α1, α2, α3, . . . , ak, where k is the order number of the secret key in the succession of secret keys used. Below, ak designates the current key and ak+1 designates the next current key.

Each time an instruction to load a datum Dᵢ into a register R_{i,0} of the bank 120 is executed by the microprocessor 2, in a step 80, the circuit 40 computes the code C_{i,αk} using a relationship C_{i,αk}=Q_{αk}(Dᵢ). The function Q_{αk} is the function Q_{α}, which was described above, parameterized by the current secret key αk. In the first iteration of step 80, the current secret key is the key α1 recorded in the register K0.

Next, in a step 82, the code C_{i,αk} is recorded in the corresponding register of the current auxiliary bank. Thus, during the first execution of step 82, the code C_{i,α1} is recorded in the register C_{i,α1} of the bank 121. For example, for this purpose, the computed code C_{i,αk} is delivered to the module 26 at the same time as the datum Dᵢ and the module 26 records the datum Dᵢ in the register R_{i,0} of the bank 120 and, in parallel, the code C_{i,αk} in the corresponding register of the current auxiliary bank.

In parallel with the execution, by the unit 22, of the instruction causing the operation D₁*D₂* . . . *Dₙ to be performed and the result Dᵣₑₛ₋ₚ of this operation to be recorded in the register R_{res-p,0}, in a step 90, the unit 30 computes a code Cᵣₑₛ₋ₜ. For this purpose, the unit uses the codes C_{1,αk}, C_{2,αk}, . . . , C_{n,αk} recorded in the current auxiliary bank and the current secret key ak. In the first iteration of step 90, it is therefore the codes C_{1,α1}, C_{2,α1}, . . . , C_{n,α1} and the key α1 that are used. The code Cᵣₑₛ₋ₜ is computed without using the result Dᵣₑₛ₋ₚ.

Next, in a step 92, the unit 30 records the code Cᵣₑₛ₋ₜ computed in the corresponding register of the current auxiliary bank, as integrity code C_{res-p,αk} associated with the datum Dᵣₑₛ₋ₚ. In the first iteration of step 92, the code Cᵣₑₛ₋ₜ is therefore recorded as code C_{res-p,α1} in the register R_{res-p,1} of the bank 121.

In a step 100, each time a datum Dᵢ is written to a register R_{i,0} of the bank 120, the circuit 42 computes the code C_{i,αk+1} using the relationship C_{i,αk+1}=Q_{αk+1}(Dᵢ). The function Q_{αk+1} is the function Q_{α}, which was described above, parameterized by the next secret key αk+1 recorded in the non-current register K0 or K1. The code C_{i,αk+1} is then recorded in the corresponding register of the non-current auxiliary bank. In the first iteration of step 100, the code C_{i,α2} is therefore recorded in the register R_{i,2} of the bank 122.

Step 100 is executed each time the module 26 loads a datum Dᵢ into the bank 120 and each time the circuit 24 writes a result Dᵣₑₛ₋ₚ to the bank 120.

In step 100, the module 28 also marks the register, in which the code C_{i,αk+1} has been recorded, as having been updated. For this purpose, here, the bit Tᵢ of the register T is set to one.

In parallel with the preceding steps, in a step 110, the module 28 detects execution errors of the unit 22 and, here, in addition verifies the integrity of the data recorded in the bank 120.

In order to detect an execution error of the unit 22, in step 110, the module 28 verifies that the code Cᵣₑₛ₋ₜ computed by the unit 30 corresponds to a code Cᵣₑₛ₋ₚ defined by the following relationship Cᵣₑₛ₋ₚ=Q_{αk}(Dᵣₑₛ₋ₚ), where the result Dᵣₑₛ₋ₚ is the one recorded in the register R_{res-p,0}. When the code Cᵣₑₛ₋ₜ computed by the hardware circuit of the unit 30 is equal, in the absence of any execution errors, to the code Cᵣₑₛ₋ₚ, then there is correspondence between the codes Cᵣₑₛ₋ₜ and Cᵣₑₛ₋ₚ if they are equal. In this case, the code Cᵣₑₛ₋ₚ is computed from the datum Dᵣₑₛ₋ₚ delivered by the unit 22 and using the relationship Cᵣₑₛ₋ₚ=Q_{αk}(Dᵣₑₛ₋ₚ). When the code Cᵣₑₛ₋ₜ computed by the hardware circuit of the unit 30 is equal, in the absence of any execution errors, to the result Dᵣₑₛ₋ₚ, then there is correspondence between the codes Cᵣₑₛ₋ₜ and Cᵣₑₛ₋ₚ if the code Cᵣₑₛ₋ₜ is equal to the result Dᵣₑₛ₋ₚ.

If there is no correspondence between the codes Cᵣₑₛ₋ₚ and Cᵣₑₛ₋ₜ, the module 28 triggers execution of a step 112 of signaling an execution error. In the contrary case, no signaling of an execution error is triggered, i.e. signaling of an execution error is inhibited.

Execution of step 110 therefore makes it possible to detect a malfunction of the unit 22, because the code Cᵣₑₛ₋ₜ corresponds to the code Cᵣₑₛ₋ₚ only if the unit 22 has correctly executed the arithmetic logic instruction.

Step 110 may also be triggered to verify the integrity of a datum recorded in the bank 120. In this case, the procedure is as described above except that the module 28 uses the datum Dᵢ and the corresponding integrity code recorded in the current auxiliary bank.

Step 110 may be triggered:
each time that a result Dᵣₑₛ₋ₚ is obtained by the unit 22, and/or
each time that an arithmetic logic instruction is about to be executed by the unit 22, just before its execution, to verify the integrity of the data Dᵢ contained in the registers R_{i,0} identified by the operands of the instruction to be executed, and/or
each time that a datum of the bank 120 is transferred to the memory 4.

In step 112, the module 28 triggers signaling of an execution error.

In response to signaling of an execution error, in a step 114, the microprocessor 2 implements one or more counter-measures. Many counter-measures are possible.

The counter-measures implemented may have very different degrees of severity. For example, the counter-measures implemented may range from a simple display or simple storage of an error message without interrupting normal execution of the machine code 32 to the microprocessor 2 being taken out of service definitively. The microprocessor 2 is considered to be out of service when it is definitively placed in a state in which it is incapable of executing any machine code. Between these extreme degrees of severity, there are many other possible counter-measures such as:
indication via a human-machine interface of the detection of errors,
immediate interruption of execution of the machine code 32 and/or reset thereof, and
deletion of the machine code 32 from the memory 4 and/or deletion of the backup copy 41 and/or deletion of the secret data.

As the machine code 32 is executed, all the bits Tᵢ of the register T are set to one. This assumes that the machine code 32 uses all the registers of the bank 120. This is generally the case. In addition, in the particular case of a machine code that does not use all the registers of the bank 120, it is always possible to add to such a machine code additional instructions that use registers that, in the absence of these additional instructions, would not be used.

In a step 130, the module 28 triggers replacement of the key αk by the key αk+1, as soon as the following two conditions are simultaneously met:
Condition 1): All the bits Tᵢ of the register T are equal to one, and
Condition 2): The counter 46 has finished counting N_{c} clock cycles.

Condition 1) indicates that all the registers of the non-current auxiliary bank have been marked as having been updated. In the first iteration, the non-current auxiliary bank is the bank 122.

Condition 2) is met once the value of the counter 46 exceeds the number N_{c}.

The time at which the module 28 triggers replacement of the secret key αk by the secret key αk+1 is denoted “trₖ” below.

In step 130, the module 28 changes the current key and the current auxiliary bank. To change the current key, the module 28 selects the non-current register K0 or K1 and then marks this selected register as being the one containing, from then on, the current key. Thus, from then on, the key αk+1 becomes the new current key αk and the previous current key is denoted ak−1. The module 28 also selects the non-current auxiliary bank and marks it as being the new current auxiliary bank. The old current auxiliary bank becomes the new non-current auxiliary bank. Thus, the one of the two auxiliary banks 121 and 122 that was the current auxiliary bank before the time trₖ becomes the non-current auxiliary bank after the time trₖ and vice versa.

After the first iteration of step 130, the current key is now the one contained in the register K1, i.e. key α2, and the current auxiliary bank is the bank 122. Therefore, for any new instruction, the execution of which starts after this time tr₁, it is the secret key α2 and the codes C_{i,α2} that are used during execution of steps 80, 82, 90, 92, 100 and 110.

In step 130, the module 28 reinitializes the counter 46, to again trigger counting of N_{c} clock cycles.

At the time trₖ, for all the arithmetic logic instructions in the process of being executed in the processing pipeline 10, the unit 30 is in the process of computing the one or more codes Cᵣₑₛ₋ₜ using the codes C_{1,αk-1}, C_{2,αk-1}, . . . , C_{n,αk-1} and the previous current key αk−1. An arithmetic logic instruction in the process of being executed at the time trₖ is an instruction, the execution of which started before the time trₖ and the execution of which has not yet ended at the time trₖ. Thus, for these instructions in the process of being executed, even after the time trₖ, it is preferable to keep the codes C_{1,αk-1}, C_{2,αk-1}, . . . , C_{n,αk-1} and the previous current key αk−1 available so as not to corrupt the computations in progress of one or more codes Cᵣₑₛ₋ₜ. Specifically, for the instructions in the process of being executed, the hardware circuits of the unit 30 have been configured before the time trₖ and this configuration is not modified after the time trₖ. Thus, after the time trₖ, the computation hardware circuits of the unit 30 continue, for all the computations of codes Cᵣₑₛ₋ₜ in progress at the time trₖ, to use the previous current auxiliary bank and the previous current key αk−1, i.e., the current bank and the current key such as they were before the time trₖ. Therefore, if the content of the previous current auxiliary bank or if the previous current key is immediately modified after the time trₖ, this may corrupt the computations of the codes Cᵣₑₛ₋ₜ in progress at the time trₖ and therefore, in the end, trigger untimely signaling of execution errors, even when no errors occur during execution of the arithmetic logic instruction by the unit 22.

Likewise, if verification of a code Cᵣₑₛ₋ₜ was in progress at the time trₖ, it is also preferable to keep the codes C_{1,αk-1}, C_{2,αk-1}, . . . , C_{n,αk-1} and the key αk−1 available so as not to trigger untimely signaling of execution errors.

Here, to avoid this, after the time trₖ, in a step 132, the module 28 inhibits any modification of the previous current key αk−1 until a time tdₖ. Thus, during the interval [trₖ; tdₖ], the module 28 continues to use the secret key αk−1 and the codes C_{i,αk-1} to finalize the computations in progress of the codes Cᵣₑₛₜ₋ₜ and the verifications in progress of codes Cᵣₑₛ₋ₜ. In addition, during the interval [trₖ; tdₖ], the module 28 inhibits any modification of the register T. Thus, the bits Tᵢ remain unchanged even if a new code C_{i,αk-1} is written to the previous current auxiliary bank.

Here, the time tdₖ is equal to the time at which the counter 46 has finished counting N_{c} clock cycles. At the time tdₖ, execution of the instructions and verifications in the process of being executed at the time trₖ will have finished, and hence from then onwards the unit 30 no longer uses the key αk−1 and the codes C_{1,αk-1}.

At the time tdₖ, in a step 134, the generator 44 generates a new key αk+1 and records it in the non-current register K0 or K1 containing the previous current key αk−1. Thus, from the time tdₖ, the previous current key αk−1 is replaced by the next current key αk+1. In step 134, the module 28 also reinitializes the register T and therefore sets all the bits Tᵢ to zero. Thus, everything described above is repeated and, in particular, replacement of the current key αk by a new current key αk+1 generated randomly or pseudo-randomly is repeated.

### SECTION III: VARIANTS

The security module may comprise more than two auxiliary banks of registers. For example, in one particular embodiment, the security module in addition comprises a third auxiliary bank of registers and a third register K2. This third auxiliary bank may be used to accelerate the frequency of change of the keys ak. This is illustrated in the particular case of replacement of the key α2 by the key α3. Here, the key α3 is generated before the time tr₁, and not at the time td₁, and recorded in the register K2. Next, between the times tr₁ and tr₂, and without waiting for the time td₁, each time a datum Dᵢ is written to a register R_{i,0} of the main bank of registers, the security module computes, then records in the third auxiliary bank of registers, the code C_{i,α3}. Thus, by virtue of use of the third auxiliary bank, it is possible to start filling this third auxiliary bank with the codes C_{i,α3} without waiting for the time td₁, i.e. the time from which the codes C_{i,α1} contained in the auxiliary bank 121 are no longer used. Next, at the time tr₂, for any new arithmetic operation executed, the security module uses the codes C_{i,α3} recorded in the third auxiliary bank to compute the code Cᵣₑₛₜ₋ₜ. From the time tr₂, the codes contained in the auxiliary bank 121 are no longer used. Therefore, it is possible to start writing the codes C_{i,α4} to the auxiliary bank 121 without waiting for the time td₂, and therefore to reiterate the above process using the auxiliary bank 121 instead of the third auxiliary bank.

In another variant, more than three auxiliary banks of registers may be used.

Other embodiments of the auxiliary banks of registers are possible. In particular, the microprocessor may comprise a single set of registers containing Nᵣ registers. Each of the registers in this set contains first, second and third bit ranges of same size. In this case, the first, second and third bit ranges correspond to registers R_{i,0}, R_{i,1} and R_{i,2} described above, respectively. In this case, each bank of registers is implemented in the same register set by partitioning each register of this set into three distinct ranges of same size. Therefore, the address ports are common to the three banks of registers. In contrast, the data ports are separate. More precisely, the data port of the set of registers is then partitioned into three data ports corresponding to the main bank 120, to the auxiliary bank 121 and to the auxiliary bank 122, respectively.

The auxiliary banks 121 and 122 are not necessarily identical to the main bank 120. For example, if the size of the integrity codes is less than the size of the processed data, the size of the registers of the banks 121 and 122 is then less than the size of the registers of bank 120.

The registers of the banks 121 and 122 may be marked as having been updated differently. For example, in step 134, the register T is not reinitialized. Instead, in the next iteration of step 130, Condition 1) is replaced by the following Condition 1a): All the bits Tᵢ of the register T are equal to zero. Next, once condition 1a) has been used in step 130, it is automatically replaced by Condition 1) and so on. Therefore, in this embodiment, Conditions 1) and 1a) are used alternately. In another variant, instead of using a single register T common to the banks 121 and 122 to do this, it is possible to use two registers T1 and T2 associated with banks 121 and 122, respectively. The registers T1 and T2 are each identical to the register T. The registers T1 and T2 operate just like the register T, except that to mark that a register of the bank 121 has been updated, it is only the register T1 that is used, and to mark that a register of the bank 122 has been updated, it is only the register T2 that is used.

As a variant, the code Cᵣₑₛ₋ₜ computed by the unit 30 is only used in a verifying step 110 triggered once the result Dᵣₑₛ₋ₚ and the code Cᵣₑₛₜ₋ₜ have been computed. The code Cᵣₑₛₜ₋ₜ computed by the unit 30 is not recorded in one of the auxiliary banks. In this case, if no execution error is signaled in step 110, the code Cᵣₑₛ₋ₜ recorded in the registers R_{res-t,1} and R_{est-t,2} are computed by the conditional-permutation circuit 42 directly from the result Dᵣₑₛ₋ₚ recorded in the register R_{res-t,0}. Thus, in this case, the codes C_{rest-t,αk} and C_{rest-t,αk+1} are computed using the following relationships: C_{rest-t,αk}=Q_{αk}(Dᵣₑₛ₋ₚ) and C_{rest-t,αk+1}=Q_{αk+1} (Dᵣₑₛ₋ₚ).

Other modes of generating a new secret key are possible. For example, the security module comprises a memory in which a high number of pre-generated secret keys are pre-recorded. Generation of a secret key then consists only in selecting, in this memory, one of the secret keys that are recorded therein.

In another embodiment, the new secret key is generated before the time trₖ or tdₖ then recorded in a temporary memory of the security module. When the number N_{c} of clock cycles has elapsed, the secret key contained in this temporary memory is copied to the register containing the previous current key, to replace this previous current key.

In a simplified embodiment, the previous secret key αk−1 and the codes C_{i,αk-1} do not continue to be used between the times trₖ and tdₖ. In other words, step 132 is omitted. In this case, the change of keys may cause untimely signaling of execution errors. However, this untimely signaling of execution errors is not necessarily unacceptable if it occurs infrequently and cannot therefore be confused with an attempt to carry out a fault-injection attack. For this purpose, typically, in this simplified embodiment, the secret key is changed less frequently.

The number N_{c} may be chosen to be greater than 300 or 1000. However, the higher the value of the number N_{c}, the lower the frequency of change of the keys ak.

As a variant, each datum Dᵢ processed by the microprocessor is a masked datum obtained by performing the following operation: Dᵢ=D_{i,c} XOR M, where:
D_{i,c} is an unmasked cleartext datum,
M is a mask, of same size as the datum D_{i,c}, and
XOR designates the Boolean operation “EXCLUSIVE OR”.

The fact that the datum Dᵢ is a masked datum does not change any of what was described above since the function Q_{α} is a function that is homomorphic with respect to Boolean operations and therefore in particular with respect to the “EXCLUSIVE OR” operation.

A plurality of the variants described above may be combined in the same embodiment.

### SECTION IV: ADVANTAGES OF THE DESCRIBED EMBODIMENTS

Pre-computing the codes C_{i,αk+1} before triggering replacement of the secret key αk by a new secret key αk+1, then recording the codes C_{i,αk+1} thus pre-computed in the non-current auxiliary bank allows the necessary codes C_{i,αk+1} to be immediately made available once replacement of the secret key αk by the new secret key αk+1 is triggered. This makes it possible to limit how much execution of the machine code is slowed down by replacement of the secret key αk by the secret key αk+1, since it is not necessary to suspend execution of new instructions by the hardware processing pipeline 10 for a period of time required to compute the various codes C_{i,αk+1} then to replace, in the auxiliary bank 121, each code C_{i,αk} by the corresponding code C_{i,αk+1}. Therefore, one key may be replaced by another more frequently, without this substantially slowing down execution of the machine code by the microprocessor. It is therefore possible to rapidly change the keys ak, this making it possible to improve the security of the microprocessor 2.

In addition, triggering replacement of the key αk by the key αk+1 only when all the registers of the auxiliary bank containing the codes C_{i,αk+1} have been updated makes it possible to avoid untimely signaling of execution errors. Specifically, it is possible for a datum Dᵢ to be used during a period [tₖ₋₁, tₖ], then to remain unused during the following period [tₖ; tₖ₊₁] before being used again during the period [tₖ₊₁; tₖ₊₂]. In this case, the code C_{i,αk+1} is recorded in one of the auxiliary banks during the period [tₖ₋₁, tₖ]. If triggering of replacement of the key αk by the key αk+1 is not conditional on the fact that all the registers of the auxiliary bank containing the code C_{i,αk+1} are marked as having been updated, during the period [tₖ; tₖ₊₁], the code C_{i,αk+2} is not computed because the datum Dᵢ is not used during this period. Therefore, during the following period [tₖ₊₁; tₖ₊₂], when the datum Dᵢ is processed by the arithmetic logic unit, the code Cᵣₑₛ₋ₜ cannot be correctly computed since the code C_{i,αk+2} does not exist in the auxiliary banks of registers. In the end, this therefore systematically triggers signaling of an execution error when the result Cᵣₑₛ₋ₜ is verified. By preventing passage to the following period until all the registers of the auxiliary banks of registers have been marked as having been updated, this problem is avoided.

Continuing to use the previous current key αk−1 and the codes C_{i,αk}−1 after the time trₖ for all the arithmetic operations, the execution of which started before the time trₖ, makes it possible to avoid untimely signaling of execution errors. In addition, this untimely signaling of execution errors is avoided without it being necessary to modify the configuration and internal registers of the hardware processing pipeline. Thus, this untimely signaling is avoided without slowing down execution of the machine code.

Recording the codes C_{i,α+2} in the non-current auxiliary bank instead of the codes C_{i,αk} that were recorded therein beforehand, makes it possible to change the secret key frequently while using only two auxiliary banks of registers. This therefore makes it possible to simplify the hardware implementation of the security module.

Setting the duration of the interval [trₖ; tdₖ] to between 5 and 300 clock cycles of the microprocessor makes it possible to increase the frequency at which the keys ak are changed while limiting or eliminating untimely signaling of execution errors caused by a change of keys.

The fact that the code Cᵣₑₛ₋ₜ computed by the unit 30 is recorded by way of code C_{rest-t,αk} in the current auxiliary bank avoids the need to compute this code C_{rest-t,αk} from the result Dᵣₑₛ₋ₚ. In addition, by proceeding in this way, the code Cᵣₑₛₜ₋ₜ may be verified at a time other than just after computing the result Dᵣₑₛ₋ₚ. For example, the code Cᵣₑₛ₋ₜ may be verified only at the moment when the corresponding datum Dᵢ is recorded in a cache memory external to the microprocessor.

1. A microprocessor equipped with an arithmetic logic unit, with a main bank of registers and with a hardware security module, in which:
a) the arithmetic logic unit is capable of executing an arithmetic logic instruction comprising an opcode and one or more operands, which arithmetic logic instruction, when it is executed by the arithmetic logic unit of the microprocessor, causes an operation D₁*D₂* . . . *Dₙ to be performed and the result of this operation to be recorded in a register R_{res-p,0} of the main bank of registers, where:
the index n is equal to the number of data Dᵢ processed by the arithmetic logic instruction, the index n being greater than or equal to one,
D₁ to Dₙ are data recorded in registers R_{1,0} to R_{n,0} of the main bank of registers, respectively, the size, in number of bits, of each of these data Dᵢ being equal to 2^{d}, where d is an integer greater than two,
the registers R_{1,0} to R_{n,0} are the registers designated by the operands of the arithmetic logic instruction,
the symbol “*” is the arithmetic or logic operation designated by the opcode of the arithmetic logic instruction,
b) the hardware security module is configured to execute the following operations:
1) each time an instruction to load a datum Dᵢ into a register R_{i,0} of the main bank of registers is executed by the microprocessor:
computing a code C_{i,α1} using a relationship C_{i,α1}=Q_{α1}(Dᵢ), where the function Q_{α1} is a preprogrammed function parameterized by a current secret key α1 prerecorded in the hardware security module and known only by the hardware security module, and
recording the computed code C_{i,α1} in a register R_{i,1}, corresponding to the register R_{i,0}, of a first auxiliary bank of registers,
2) in parallel with execution, by the arithmetic logic unit, of the arithmetic logic instruction causing the operation D₁*D₂* . . . *Dₙ to be performed and the result of this operation to be recorded in the register R_{res-p,0} of the main bank of registers, computing a code Cᵣₑₛ₋ₜ using the codes C_{1,α1}, C_{2,α1}, . . . , C_{n,α1} recorded in the first auxiliary bank of registers and without using the result Dᵣₑₛ₋ₚ, then
3) verifying that the computed code Cᵣₑₛ₋ₜ corresponds to a code Cᵣₑₛ₋ₚ obtained from the result Dᵣₑₛ₋ₚ and triggering signaling of an execution error if the code Cᵣₑₛ₋ₜ does not correspond to the code Cᵣₑₛ₋ₚ and, in the contrary case, inhibiting this signaling, wherein the hardware security module is also configured to execute the following operations:
4) each time a datum Dᵢ is written to a register R_{i,0} of the main bank of registers and before replacement of the current secret key α1 by a new secret key α2 is triggered:
computing a code C_{i,α2} using a relationship C_{i,α2}=Q_{α2}(Dᵢ) where the function Q_{α2} is the same preprogrammed function as the function Q_{α1} except that the current secret key α1 is replaced by the new secret key α2, then
recording the computed code C_{i,α2} in a register R_{i,2}, corresponding to the register R_{i,0}, of a second auxiliary bank of registers and marking this register as having been updated,
5) only when all the registers of the second auxiliary bank have been marked as having been updated, triggering, at a time tr₁, replacement of the current secret key α1 by the new secret key α2 and, from this time tr₁, for any new arithmetic logic instruction, the execution of which starts after this time tr₁, using the secret key α2 and the codes C_{i,α2} recorded in the second auxiliary bank of registers instead of the secret key α1 and the codes C_{i,α1} recorded in the first auxiliary bank of registers, respectively, to compute and verify the code Cᵣₑₛₜ₋ₜ.

2. The microprocessor as claimed in claim 1, wherein the hardware security module is configured to, after the time tr₁, for any arithmetic logic instruction, the execution of which started before the time tr₁ and the execution of which has not yet ended at the time tr₁, continue to use the secret key α1 and the codes C_{i,α1} recorded in the first auxiliary bank of registers to finalize the computation of the code Cᵣₑₛₜ₋ₜ and to verify this code Cᵣₑₛₜ₋ₜ.

3. The microprocessor as claimed in claim 2, wherein the hardware security module is configured to:
between the time tr₁ and a time td₁, for any arithmetic logic instruction, the execution of which started before the time tr₁ and the execution of which has not yet ended at the time tr₁, continue to use the secret key α1 and the codes C_{i,α1} recorded in the first auxiliary bank of registers to finalize the computation of the code Cᵣₑₛₜ₋ₜ and to verify this code Cᵣₑₛₜ₋ₜ, and
from the time td₁:
each time a datum Dᵢ is written to a register R_{i,0} of the main bank of registers and before replacement of the secret key α2 by a new secret key α3 is triggered:
compute a code C_{i,α3} using a relationship C_{i,α3}=Q_{α3}(Dᵢ) where the function Q_{α3} is the same preprogrammed function as the function Q_{α1} except that the secret key α1 is replaced by the secret key α3, then
record the computed code C_{i,α3} in the register R_{i,1}, corresponding to the register R_{i,0}, of the first auxiliary bank of registers,
in response to triggering, at a time tr₂ subsequent to the time td₁, of the replacement of the secret key α2 by the new secret key α3, for any new arithmetic logic instruction, the execution of which starts after this time tr₂, use the secret key α3 and the codes C_{i,α3} recorded in the first auxiliary bank of registers instead of the secret key α2 and the codes C_{i,α2} recorded in the second auxiliary bank of registers, respectively, to compute and verify the code Cᵣₑₛₜ₋ₜ.

4. The microprocessor as claimed in claim 3, wherein the hardware security module is configured to trigger a counter that counts the number of clock cycles elapsed since the time tr₁, and to compare the number of clock cycles counted by this counter with a predetermined number, the time td₁ corresponding to the time when the value of this counter exceeds this predetermined number, the predetermined number being between 5 and 300.

5. The microprocessor as claimed in claim 1, wherein the hardware security module comprises a computing unit capable of:
in parallel with execution, by the arithmetic logic unit, of the arithmetic logic instruction causing the operation D₁*D₂* . . . *Dₙ to be performed, executing computation of the code Cᵣₑₛ₋ₜ using the codes C_{1,α1}, C_{2,α1}, . . . , C_{n,α1} recorded in the first auxiliary bank of registers and without using the result Dᵣₑₛ₋ₚ, and
recording the computed code Cᵣₑₛ₋ₜ in the first auxiliary bank of registers as code C_{rest-t,α1}.

6. The microprocessor as claimed in claim 1, wherein the microprocessor comprises a hardware pipeline for processing instructions comprising a succession of stages that process one after another each instruction to be executed of the machine code, this succession of stages comprising at least the following stages: an instruction loader, a decoder, and the arithmetic logic unit, each of these stages being capable of working in parallel with the other stages.

7. The microprocessor as claimed in claim 6, wherein:
the main bank of registers comprises at least two address ports and at least two data ports with a view to making it possible to simultaneously load two data to be processed by the arithmetic logic unit,
the first and second auxiliary banks of registers each comprise at least two address ports and at least two data ports with a view to making it possible to simultaneously load two codes to be processed by the computing unit.

8. The microprocessor as claimed in claim 1, wherein the function Q_{α} is defined by the following relationship: Q_{α}(Dᵢ)=P o F_{α}(Dᵢ), where P is a predetermined function and F_{α} is a function defined by the following relationship: F_{α}(Dᵢ)=E₀ o . . . o E_{q} o . . . o E_{NbE-1}(Dᵢ), where each function E_{q} is a transposition stage and the index q is an order number between zero and NbE-1, where NbE is an integer greater than one and less than or equal to d, each transposition stage E_{q} being defined by the following relationship: E_{q}(x)=T_{αm,q} o . . . o T_{αj,q} o . . . o T_{α1,q} o T_{α0,q}(x), where:
x is a variable the size of which, in number of bits, is equal to the size of the datum Dᵢ,
T_{αj,q} is a conditional transposition, parameterized by the parameter α_{j,q}, that permutes two blocks of bits B_{2j+1,q} and B_{2j,q} of the variable x when the parameter α_{j,q} is equal to a first value and that does not permute these two blocks of bits when the parameter α_{j,q} is equal to a second value, the transposition T_{αj,q} differing from all the other transpositions of the function F_{α} in that it is the only one that permutes the two blocks B_{2j+1,q} and B_{2j,q} when the parameter α_{j,q} is equal to the first value, the blocks B_{2j+1,q} and B_{2j,q} of all the transpositions T_{αj,q} of the stage E_{q} being different from one another and not overlapping so that all the transpositions T_{αj,q} of the stage E_{q} may be executed in parallel,
“m+1” is the total number of transpositions T_{αj,q} of the stage E_{q},
“j” is an order number identifying the transposition T_{αj,q} among the other transpositions of the stage E_{q},
the symbol “o” designates the operation of function composition,
the concatenation of the bits of all the parameters α_{j,q} of all the stages E_{q} is equal to the value of the secret key α, and
for all the stages E_{q} for which q is less than NbE-1 and for all the transpositions T_{αj,q} of this stage, the blocks B_{2j+1,q} and B_{2j,q} are located inside a given block of larger size permuted by a transposition of the above stage E_{q+1} when the parameter of this transposition of the above stage E_{q+1} is equal to the first value.

9. A method for executing a binary code using a microprocessor equipped with an arithmetic logic unit, with a main bank of registers and with a hardware security module, in which:
a) the arithmetic logic unit executes an arithmetic logic instruction comprising an opcode and one or more operands, which arithmetic logic instruction, when it is executed by the arithmetic logic unit of the microprocessor, causes an operation D₁*D₂* . . . *Dₙ to be performed and the result of this operation to be recorded in a register R_{res-p,0} of the main bank of registers, where:
the index n is equal to the number of data Dᵢ processed by the arithmetic logic instruction, the index n being greater than or equal to one,
D₁ to Dₙ are data recorded in registers R_{1,0} to R_{n,0} of the main bank of registers, respectively, the size, in number of bits, of each of these data Dᵢ being equal to 2^{d}, where d is an integer greater than two,
the registers R_{1,0} to R_{n,0} are the registers designated by the operands of the arithmetic logic instruction,
the symbol “*” is the arithmetic or logic operation designated by the opcode of the arithmetic logic instruction,
b) the hardware security module executes the following operations:
1) each time an instruction to load a datum Dᵢ into a register R_{i,0} of the main bank of registers is executed by the microprocessor:
computing a code C_{i,α1} using a relationship C_{i,α1}=Qₐ₁(Dᵢ), where the function Q_{α1} is a preprogrammed function parameterized by a secret key α1 prerecorded in the hardware security module and known only by the hardware security module, and
recording the computed code C_{i,α1} in a register R_{i,1}, corresponding to the register R_{i,0}, of a first auxiliary bank of registers,
2) in parallel with execution, by the arithmetic logic unit, of the arithmetic logic instruction causing the operation D₁*D₂* . . . *Dₙ to be performed and the result of this operation to be recorded in the register R_{res-p,0} of the main bank of registers, computing a code Cᵣₑₛ₋ₜ using the codes C_{1,α1}, C_{2,α1}, . . . , C_{n,α1} recorded in the first auxiliary bank of registers and without using the result Dᵣₑₛ₋ₚ, then
3) verifying that the computed code Cᵣₑₛ₋ₜ corresponds to a code Cᵣₑₛ₋ₚ obtained from the result Dᵣₑₛ₋ₚ and triggering signaling of an execution error if the code Cᵣₑₛ₋ₜ does not correspond to the code Cᵣₑₛ₋ₚ and, in the contrary case, inhibiting this signaling, wherein the hardware security module also executes the following operations:
4) each time a datum Dᵢ is written to a register R_{i,0} of the main bank of registers and before replacement of the secret key α1 by a new secret key α2 is triggered:
computing a code C_{i,α2} using a relationship C_{i,α2}=Q_{α2}(Dᵢ) where the function Q_{α2} is the same preprogrammed function as the function Q_{α1} except that the secret key α1 is replaced by the secret key α2, then
recording the computed code C_{i,α2} in a register R_{i,2}, corresponding to the register R_{i,0}, of a second auxiliary bank of registers and marking this register R_{i,2} as having been updated,
4) only when all the registers of the second auxiliary bank have been marked as having been updated, triggering, at a time tr₁, replacement of the secret key α1 by the secret key α2 and, from this time tr₁, for any new arithmetic logic instruction, the execution of which starts after this time tr₁, using the secret key α2 and the codes C_{i,α2} recorded in the second auxiliary bank of registers instead of the secret key α1 and the codes C_{i,α1} recorded in the first auxiliary bank of registers, respectively, to compute and verify the code Cᵣₑₛₜ₋ₜ.
